(19) United States
(12) Patent Application Publication
(10) Pub. No.: US 2020/0079186 A1
(43) Pub. Date: Mar. 12, 2020

(54) VEHICLE REAR SLIDER WINDOW ASSEMBLY WITH WATER DRAINAGE CHANNEL

(71) Applicant: Magna Mirrors of America, Inc., Holland, MI (US)

(72) Inventors: Darin J. Snider, Holland, MI (US); Michael J. Hulst, Holland, MI (US); David L. Guillozet, Hamilton, MI (US)

(21) Appl. No.: 16/565,527

(22) Filed: Sep. 10, 2019

Related U.S. Application Data
(60) Provisional application No. 62/729,437, filed on Sep. 11, 2018.

(51) Int. Cl. B60J 1/18; B60J 1/00

(52) U.S. Cl. CPC B60J 1/1853; B60J 1/007

(57) ABSTRACT

A slider window assembly for a vehicle includes at least one fixed window panel and a movable window panel that is movable along upper and lower rails at the fixed window panel(s). The lower rail includes a U-shaped channel and an attaching side for attaching the lower rail at the fixed window panel(s). The lower rail includes a water drainage channel established at the attaching side and having an upper water drainage channel and a lower water drainage channel. The upper water drainage channel has an inlet at an upper edge of the lower rail at the fixed window panel. Water flowing along the upper edge of the lower rail flows into the upper water drainage channel and down the upper water drainage channel and into and along the lower water drainage channel and out of the slider window assembly.

### CROSS REFERENCE TO RELATED APPLICATION

The present application claims the filing benefits of U.S. provisional application Ser. No. 62/729,437, filed Sep. 11, 2018, which is hereby incorporated herein by reference in its entirety.

### FIELD OF THE INVENTION

The present invention relates to a slider window assembly for a vehicle and, more particularly, a rear slider window assembly for a vehicle and, more particularly, a rear slider window assembly for a pickup truck or the like.

### BACKGROUND OF THE INVENTION

It is known to provide a slider window assembly for an opening of a vehicle, such as a rear slider window assembly for a rear opening of a pickup truck. Conventional slider window assemblies for rear openings of trucks or the like typically include three or more panels, such as two fixed window panels and a slidable window panel. The slidable window panel is supported by rails that may be adhesively bonded at the surface of the fixed window panels. The slidable window panel may be moved along the rails to open and close the window. The slidable window panel may be driven or moved by a cable drive system.

### SUMMARY OF THE INVENTION

The present invention provides a rear slider window assembly that has upper and lower rails or channels adhesively attached or bonded at the inner surface of the fixed window panel or panels. The lower rail includes one or more water drainage channels that include a lower drainage channel that drains water that collects in and along the lower rail. The water drainage channels include an upper drainage channel that drains water that may flow along an upper edge of the lower rail at the window panel(s). Thus, the drainage channels function to drain water from within the lower rail and from above and along the lower rail at the window panel (where water may collect along the rail-window interface if it does not flow down into the rail). The rear slider window assembly of the present invention thus provides enhanced water drainage from along and within the lower rail or channel.

In accordance with an aspect of the window assembly, the window assembly includes slider comprises a lower rail having a U-shaped channel and a mounting structure or attaching side or structure (such as a recessed area along the side of the lower rail that opposes the fixed window panel for receiving adhesive therein for adhesively attaching the lower rail at the fixed window panel) for attaching the lower rail at the fixed window panel. The lower rail comprises a water drainage channel established at the mounting structure or attaching side of the lower rail that opposes the fixed window panel. The water drainage channel comprises an upper water drainage channel and a lower water drainage channel. The lower water drainage channel has an inlet at the bottom of the U-shaped channel to drain water from within the U-shaped channel down the lower water drainage channel and out of the slider window assembly. The upper water drainage channel has an inlet at an upper edge of the lower rail at the fixed window panel, and wherein water flowing along the upper edge of the lower rail at the fixed window panel flows into the upper water drainage channel via the an inlet at the upper edge of the lower rail and down the upper water drainage channel and into and along the lower water drainage channel and out of the slider window assembly.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear slider window assembly in accordance with the present invention;

FIG. 2 is a rear or exterior view of the rear slider window assembly, showing the water drains at opposite sides of the window assembly;

FIG. 3 is a front or interior view of the rear slider window assembly of FIG. 2;

FIG. 4 is a perspective view of the lower rail, showing the water drain channel;

FIG. 5 is a perspective view of another lower rail, with a water drain channel that only drains water that collects within the lower rail or channel;

FIG. 6 is a sectional view of the water drain channel and lower rail of FIG. 4;

FIG. 7 is a sectional view of the water drain channel and lower rail of FIG. 5;

FIG. 8 is another view of the lower rail and water drain channel of FIG. 4, showing adhesive beads disposed at the rail for attaching the rail at the window panel(s);

FIG. 9 is another view of the lower rail and water drain channel of FIG. 5, showing adhesive beads disposed at the rail for attaching the rail at the window panel(s);

FIG. 10 is another view similar to FIG. 8, showing the water drainage path for water that may collect at or flow along an upper edge of the lower rail; and

FIG. 11 is another view similar to FIG. 9, showing that water that flows along the upper edge of the lower rail will continue to flow along the lower rail.

### DESCRIPTION OF THE PREFERRED EMBODIMENTS

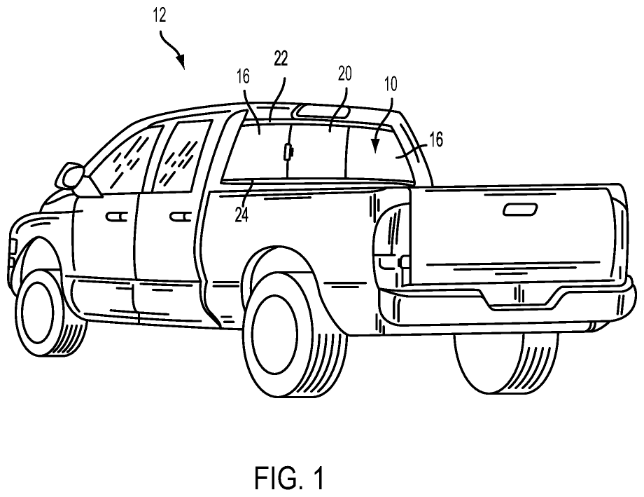

Referring now to the drawings and the illustrative embodiments depicted therein, a rear slider window assembly 10 of a vehicle 12 (such as a pickup truck or the like) includes a fixed window panel 16 (or a pair of fixed window panels) having an opening established therethrough, and a movable window panel 20 that is movable relative to a frame or rails 22, 24 and fixed window panel 16 between an opened position and a closed position (FIG. 1). The rails include an upper rail 22 and a lower rail 24, with the upper and lower edge regions of the movable window panel 20 (FIG. 1) movably or slidably received in and along the respective upper and lower rails 22, 24. The lower rail 24 includes one or more water drainage channels 26 (such as one toward each side of the window assembly), as discussed below. The water drainage channels include a lower drain channel 28 that drains water that collects within the lower rail or channel and an upper drain channel 30 that drains water that collects or flows along the upper edge of the upper rail at the fixed window panel, as also discussed below.

In the illustrated embodiment, the window assembly comprises a hole-in-glass window configuration, where a single fixed glass panel 16 has an aperture or hole or opening established therethrough to define separate spaced apart fixed window panels or panel portions. Optionally, the window assembly may comprise two fixed window panels or panel portions that are spaced apart so as to define an opening therebetween (and with upper and lower appliqués or trim or filler panels or elements disposed at the upper and lower regions of the opening and between the fixed window panels).

Upper and lower rails 22, 24 may comprise any suitable channel or rail element configured to slidably receive an upper or lower edge portion of the movable window panel. Slider or movable window panel 20 is movable along lower rail 24 and upper rail 22 to open and close the aperture or opening, such as in a manner similar to known slider window assemblies. The movable window panel 20 may include or may be disposed at a lower carrier, which may receive the lower perimeter edge region of the slider window panel 20 therein and is slidably or movably received in the channel portion of the lower rail 24.

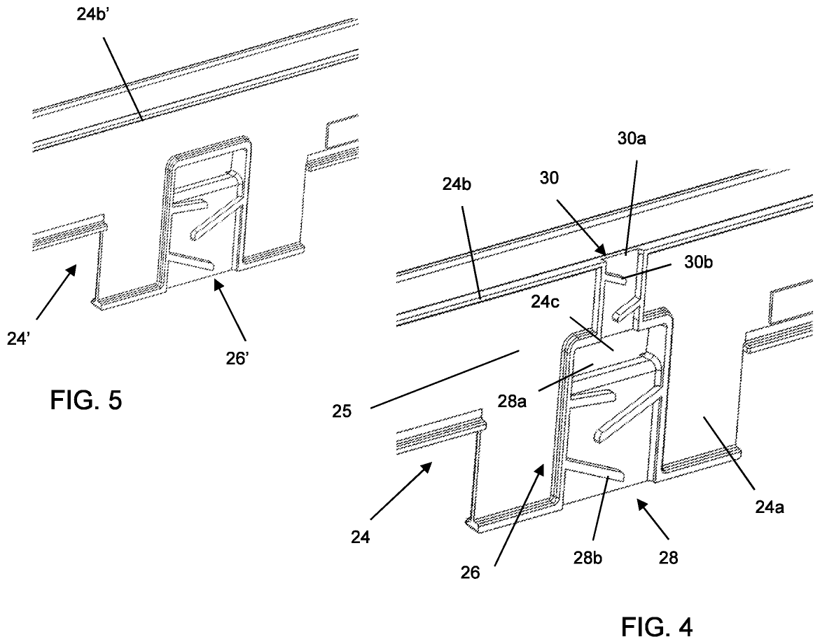

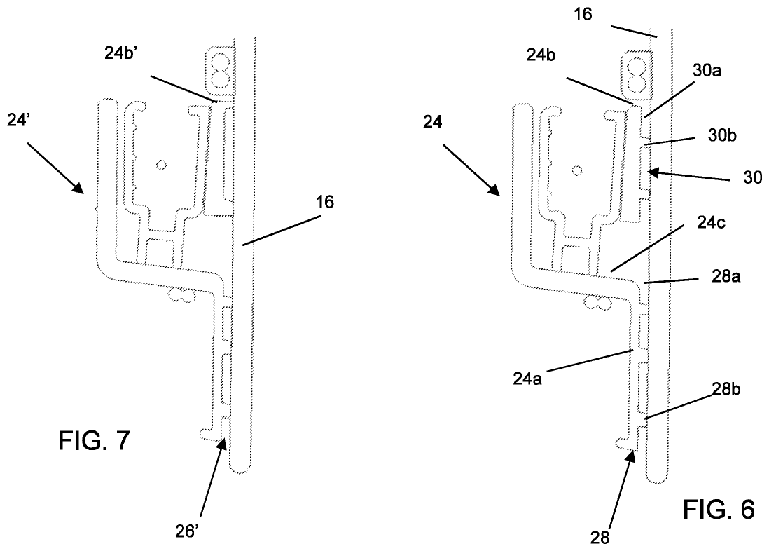

As shown in FIGS. 4, 6 and 8, the water drainage channels 26 are formed as part of the lower rail 24 and part of a lower extension 24a of the lower rail, and provide a channel or conduit or passageway for water to flow through (between the fixed window panel and the lower rail and lower extension). The water drainage channels are established at a mounting structure or attaching side 25 of the lower rail 24. The attaching side or mounting structure 25 provides a recess for receiving adhesive beads 32 for adhesively attaching or bonding the lower rail at the fixed window panel, with a perimeter lip 25a that engages the window panel and functions to establish the bond-line thickness of the adhesive that attaches the rail at the window panel. The perimeter lip 25a borders and defines or establishes the recess/channel between the window panel and the structure of the lower rail, with the water drainage passageway or recess/channel being bounded by the wall or lip of the structure that engages the window panel to provide a closed channel (closed and bounded by the lip, the window panel and the wall of the mounting structure and U-shaped channel) through which water flows (and that also functions to establish the bond-line thickness of the adhesive disposed at other recesses of the structure of the lower rail). Thus, the water drainage channels are provided between the rail structure and the fixed window panel 16 when the lower rail is adhesively attached or bonded at the fixed window panel.

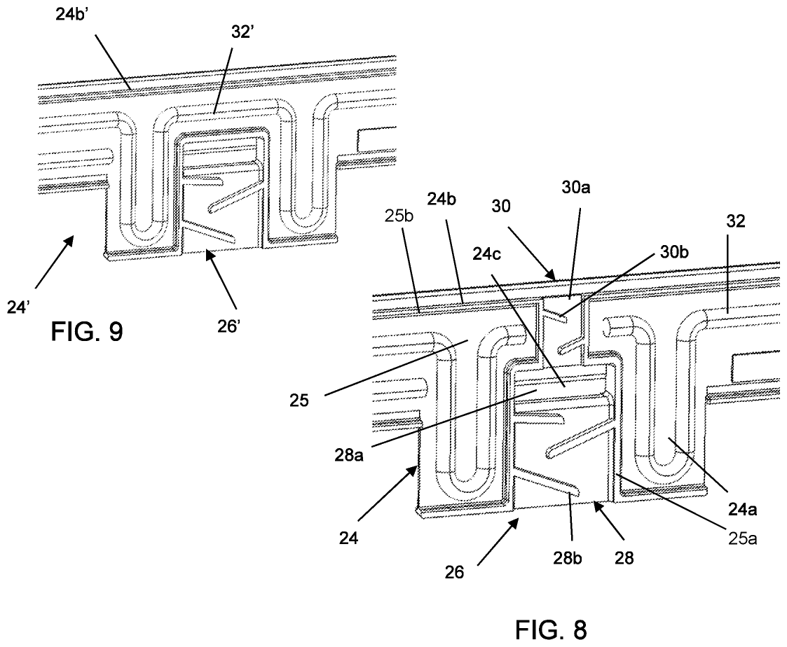

The lower channel 28 of the water drainage channel provides an inlet or opening 28a at a lower region of the U-shaped channel of the lower rail or channel 24, such that water flows into the lower drainage channel 28 (via the opening 28a) and downward along the lower drainage channel 28. The inlet 28a is established through the side wall and/or the bottom wall of the U-shaped channel such that water that may accumulate in the U-shaped channel can readily flow through the inlet and into the lower water drainage channel. In the illustrated embodiment, baffles or diverters 28b are established to guide the flow of water through the passageway or channel and to reduce or limit wind noise as the vehicle travels along a road or highway or the like. As can be seen with reference to FIG. 8, the baffles 28b are established at the recessed channel and may span between the wall of the attaching side or mounting structure and the window panel (when the lower rail is adhesively attached at the window panel), such that water flowing from the inlet 28a along the channel 28 changes direction as it flows along the baffles 28b so that the water does not flow directly downward along the channel.

The upper drainage channel 30 of the water drainage channel 26 is established between and provides a flow channel or conduit between the upper edge 24b of the lower rail 24 and an upper end of the lower drainage channel 28. The upper drainage channel 30 of the water drain channel provides an inlet or opening 30a at the upper edge 24b of the side wall of the U-shaped channel of the lower rail 24, such that water flows into the upper drainage channel 30 (via the inlet or opening 30a) and downward along the upper drainage channel 30 and into the lower drainage channel 28. The inlet 30a is established through the upper perimeter lip or structure 25b of the lower rail side wall such that water that may be at the upper edge of the U-shaped channel and at the window panel can readily flow through the inlet and into the upper water drainage channel. In the illustrated embodiment, baffles or diverters 30b are established at the upper drainage channel 30 to guide the flow of water as the water flows down through the upper drainage channel between the lower rail 24 and the fixed window panel 16, and to reduce or limit wind noise as the vehicle travels along a road or highway or the like. As can be seen with reference to FIG. 8, the baffles 30b are established at the recessed channel and may span between the wall of the attaching side or mounting structure and the window panel (when the lower rail is adhesively attached at the window panel), such that water flowing from the inlet 30a along the channel 30 changes direction as it flows along the baffles 30b so that the water does not flow directly downward along the channel.

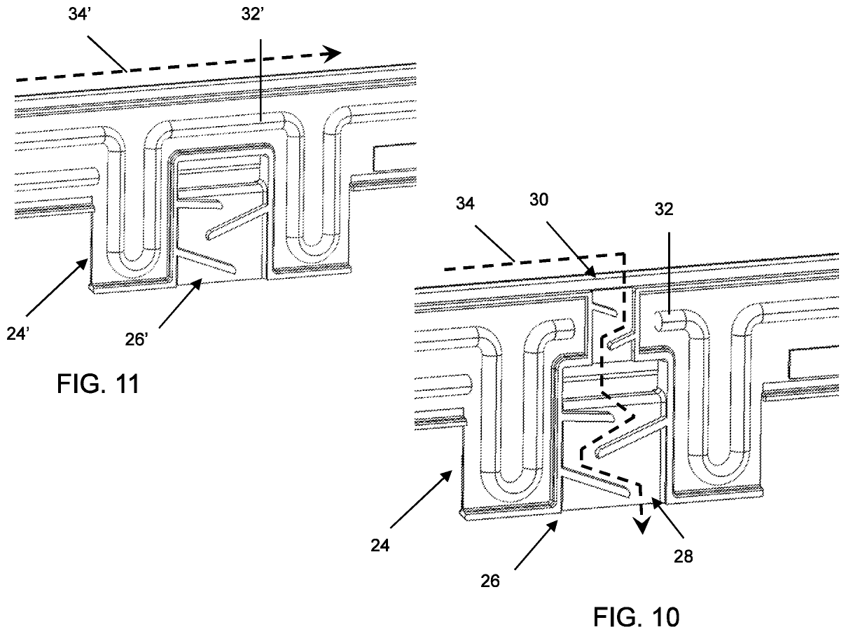

With reference to FIG. 10, water 34 that is flowing along the upper edge 24b of the lower rail 24 flows down into the inlet or opening 30a of the upper drainage channel and flows into the lower drainage channel 28 and down the drainage channel to the exit at the lower end of the water drainage channel. The lower rail 24 is formed so that the bottom 24c of the U-shaped channel is sloped downward toward the fixed window panel 16, such that water (or other fluid) flowing or collecting in the lower rail is directed toward the window panel so that it will readily flow into the opening 28a and into the lower drainage channel. Likewise, water flowing down from the upper drainage channel 30 will not flow into the U-shaped channel of the lower rail 24, but instead will flow down into the lower drainage channel 28 and out of the window assembly. This is illustrated in FIG. 10, where the water 34 drops down from the upper drainage channel 30 and into the lower drainage channel 28, and does not flow into the U-shaped channel of the lower rail 24.

As shown in FIGS. 5, 7 and 9, if the lower rail 24′ only has the lower drain channel 26′, there is no path for water that may collect or flow along the upper edge 24b′ of the lower rail, such that water flowing there will flow to either end of the lower rail where it will not drain properly. This is illustrated in FIG. 11, which shows the water flow 34′ across and along the upper edge 24b′ of the lower rail 24′, which may result in the water eventually flowing into the vehicle.

As shown in FIGS. 9 and 11, when adhesively attaching or bonding the lower rail 24′ at the fixed window panel, the adhesive bead 32′ may be dispensed along the lower rail and above the drainage channel 26′. However, with the upper drainage channel provided, and such as shown in FIGS. 8 and 10, the adhesive bead 32 is broken or not dispensed above the lower drainage channel 28 of the lower rail 24, so as to not interfere with the upper drainage channel 30, whereby the water flow 34 follows the path or conduit or passageway provided by the upper drainage channel 30 and the lower drainage channel 28.

Therefore, the present invention provides enhanced drainage of water that may collect at the lower rail. In addition to directing flow of water from within the U-shaped channel of the lower rail 24, the water drainage channel of the present invention also provides for drainage of water from along the upper edge of the lower rail. The water drainage channel is formed as a recess at the attaching side or surface of the lower rail, such that a perimeter lip or engaging surface or lip of the lower rail forms the side boundaries of the channel (while also establishing the bond-line thickness for the adhesive disposed at the recessed regions of the lower rail outside of the water drainage channels), with the channel being defined by and closed by the wall of the lower rail, the side boundaries or perimeter lips or engaging lips and the window panel.

The water drainage channels or conduits may utilize aspects of the channels or conduits described in U.S. Pat. No. 8,881,458 and/or U.S. patent application Ser. No. ______, filed Sep. 10, 2019 for VEHICLE REAR SLIDER WINDOW ASSEMBLY WITH WATER DIVERTERS (Attorney Docket DON02 P3663), which are hereby incorporated herein by reference in their entireties. For example, a plurality of diverters may be disposed along the bottom wall in the U-shaped channel to divert water toward the window panel and toward the inlet to the lower water drainage channel.

The upper and lower rails may comprise any suitable channel element configured to slidably receive the movable window panel and may be formed via any suitable forming means. For example, the channel portions and rails may be formed via an injection molding process. The rails may comprise any suitable material or materials, such as, for example, a rigid or substantially rigid molded polymeric material (such as a polyvinylchloride material or PC-ABS or the like), and preferably a rigid polymeric material or engineered plastic material. The rails may be adhered or bonded to the respective window panels and/or sheet metal via any suitable adhesive, such as, for example, by utilizing aspects of the window assemblies described in U.S. Pat. Nos. 10,023,026; 5,551,197 and/or 5,853,895, which are hereby incorporated herein by reference in their entireties.

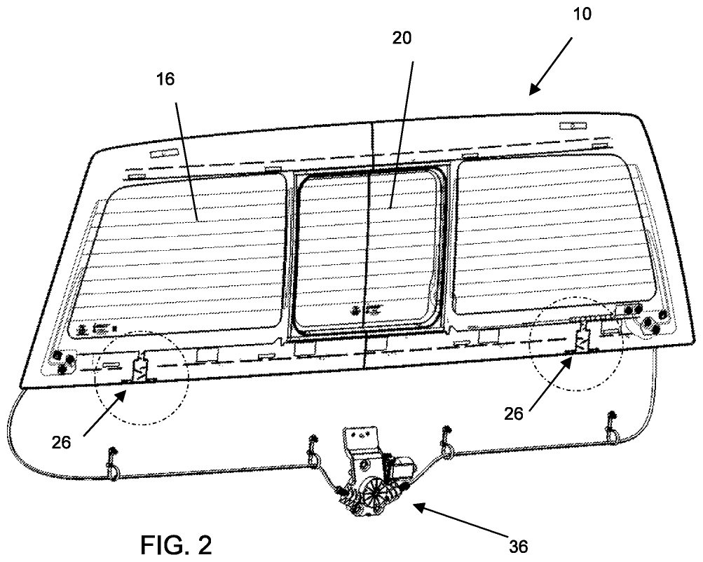

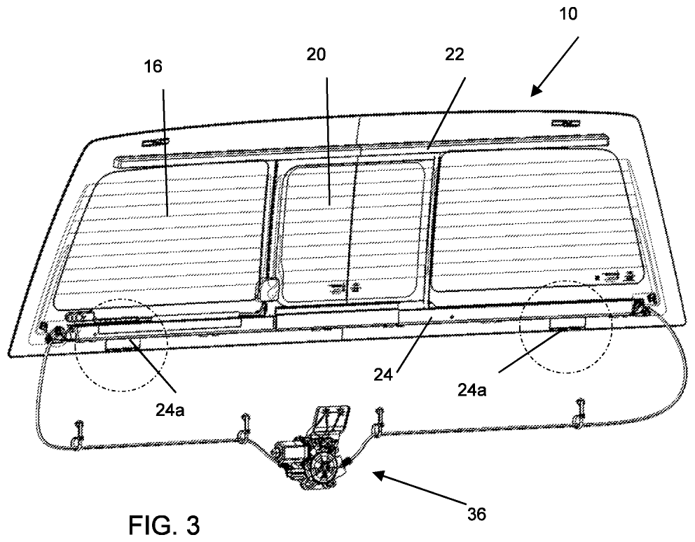

The movable window panel may be movable between its opened and closed positions via any suitable means, such as via manual pushing or pulling at the window panel and/or in response to actuation of a drive motor of a drive motor assembly or system 36 (FIGS. 2 and 3), which may move cables or wires of cable assemblies relative to a sheath of the cable assemblies or the like to impart horizontal movement of the slider window panel 20 along the rails 22, 24. Optionally, the drive motor assembly may utilize aspects of the drive assemblies of the types described in U.S. Pat. Nos. 4,920,698; 4,995,195; 5,146,712; 5,531,046; 5,572,376; 6,955,009 and/or 7,073,293, and/or U.S. Publication Nos. US-2004-0020131 and/or US-2008-0127563, which are all hereby incorporated herein by reference in their entireties.

The benefits of embodiments of the slider window assembly of the present invention may also be realized in vehicular movable window assemblies other than a rear slider window assembly for a pickup truck or the like, such as (for example) a slider window assembly suitable for use as a movable side window for a vehicle such as a van or a bus. The window assembly may utilize aspects of the elements and window assemblies described in U.S. Pat. Nos. 8,915,018 and/or 8,881,458, which are hereby incorporated herein by reference in their entireties.

Optionally, the fixed window panel and movable window panel of the window assembly of the present invention may include one or more electrically conductive elements, such as heater grids or the like, which may be powered utilizing aspects of the window assemblies described in U.S. Pat. Nos. 8,402,695 and/or 8,881,458, which are hereby incorporated herein by reference in their entireties. The window assembly may include a heater grid on each of the fixed window panels and on the movable window panels, with a heating system that provides power to the heater grid on the movable window panel irrespective of the position of the movable window panel relative to the fixed window panel and throughout the range of movement of the movable window panel between its opened and closed positions, such as by utilizing aspects of the window assemblies described in U.S. Pat. Nos. 8,402,695 and/or 8,881,458, incorporated above.

Optionally, the window assembly or assemblies of the present invention may utilize aspects of the window assemblies described in U.S. Pat. Nos. 8,915,018; 8,881,458; 8,402,695; 7,073,293; 7,003,916; 6,119,401; 6,026,611; 5,996,284; 5,799,444 and/or 6,691,464, and/or U.S. Publication Nos. US-2014-0047772; US-2006-0107600; US-2008-0127563; US-2004-0020131 and/or US-2003-0213179, all of which are hereby incorporated herein by reference in their entireties.

Changes and modifications to the specifically described embodiments may be carried out without departing from the principles of the present invention, which is intended to be limited only by the scope of the appended claims, as interpreted according to the principles of patent law.

1. A slider window assembly for a vehicle, said slider window assembly comprising:
at least one fixed window panel, said at least one fixed window panel defining an opening;
an upper rail and a lower rail attached at said at least one fixed window panel;
a movable window panel that is movable along said upper rail and said lower rail, wherein said movable window panel is movable between a closed position, where said movable window panel is disposed at said opening, and an opened position, where said movable window panel is disposed at least partially along said at least one fixed window panel;
wherein said lower rail comprises a U-shaped channel and an attaching side for attaching said lower rail at said at least one fixed window panel;
wherein said lower rail comprises a water drainage channel established at said attaching side and comprising an upper water drainage channel and a lower water drainage channel;
wherein said lower water drainage channel has an inlet at a bottom region of the U-shaped channel to drain water from within the U-shaped channel down said lower water drainage channel and out of said slider window assembly; and
wherein said upper water drainage channel has an inlet at an upper edge of said lower rail at said at least one fixed window panel, and wherein water flowing along the upper edge of said lower rail at said at least one fixed window panel flows into said upper water drainage channel via the an inlet at the upper edge of said lower rail and down said upper water drainage channel and into and along said lower water drainage channel and out of said slider window assembly.

2. The slider window assembly of claim 1, wherein said upper and lower water drainage channels comprise baffles established therein.

3. The slider window assembly of claim 1, wherein said attaching side includes a lower extension at a lower portion of said lower rail below the U-shaped channel, and wherein said lower water drainage channel is established at said lower extension.

4. The slider window assembly of claim 1, wherein said attaching side includes a side wall of the U-shaped channel of said lower rail, and wherein said upper water drainage channel is established at the side wall of the U-shaped channel between the inlet of said upper water drainage channel and the inlet of said lower water drainage channel.

5. The slider window assembly of claim 4, wherein said upper water drainage channel is established as a recess at a surface of the side wall of the U-shaped channel that opposes said at least one fixed window panel when said lower rail is attached at said at least one fixed window panel.

6. The slider window assembly of claim 5, wherein said lower rail is adhesively attached at said at least one fixed window panel via a bead of adhesive that is received in a recessed portion of the side wall that is separated from said upper water drainage channel by a lip of the side wall of the U-shaped channel that engages said at least one fixed window panel when said lower rail is adhesively attached at said at least one fixed window panel.

7. The slider window assembly of claim 4, wherein said attaching side includes a lower extension below the U-shaped channel and extending downward from the side wall, and wherein said lower water drainage channel is established at said lower extension.

8. The slider window assembly of claim 7, wherein said lower water drainage channel is established as a recess at a surface of said lower extension that opposes said at least one fixed window panel when said lower rail is attached at said at least one fixed window panel.

9. The slider window assembly of claim 8, and wherein said lower rail is adhesively attached at said at least one fixed window panel via a bead of adhesive that is received in a recessed portion of said lower extension that is separated from said lower water drainage channel by a lip of said lower extension that engages said at least one fixed window panel when said lower rail is adhesively attached at said at least one fixed window panel.

10. The slider window assembly of claim 1, wherein said at least one fixed window panel comprises a single fixed window panel having an opening therethrough.

11. The slider window assembly of claim 1, wherein said at least one fixed window panel comprises first and second fixed window panels defining an opening therebetween.

12. A slider window assembly for a vehicle, said slider window assembly comprising:
at least one fixed window panel, said at least one fixed window panel defining an opening;
an upper rail and a lower rail attached at said at least one fixed window panel;
a movable window panel that is movable along said upper rail and said lower rail, wherein said movable window panel is movable between a closed position, where said movable window panel is disposed at said opening, and an opened position, where said movable window panel is disposed at least partially along said at least one fixed window panel;
wherein said lower rail comprises a U-shaped channel having a bottom wall and first and second side walls, and wherein the first side wall of the U-shaped channel opposes said at least one fixed window panel;
wherein said lower rail comprises a water drainage channel, and wherein said water drainage channel comprises a recess along the first side wall of the U-shaped channel, and wherein, with said lower rail attached at said at least one fixed window panel, said water drainage channel is defined by said at least one fixed window panel and the recess along the first side wall; and
wherein said water drainage channel has an inlet at an upper edge of the first side wall of the U-shaped channel of said lower rail at said at least one fixed window panel, and wherein water flowing along the upper edge of the first side wall of the U-shaped channel of said lower rail at said at least one fixed window panel flows into said water drainage channel via the an inlet at the upper edge of the first side wall of the U-shaped channel of said lower rail and down said water drainage channel and out of said slider window assembly.

13. The slider window assembly of claim 12, wherein said lower rail comprises a lower water drainage channel, and wherein said lower water drainage channel comprises a recess along a portion of said lower rail that extends downward from the U-shaped channel, and wherein the portion of said lower rail opposes said at least one fixed window panel, and wherein, with said lower rail attached at said at least one fixed window panel, said lower water drainage channel is defined by said at least one fixed window panel and the recess along the portion of said lower rail.

14. The slider window assembly of claim 13, wherein said lower water drainage channel has an inlet at the bottom wall and/or the first side wall of the U-shaped channel to drain water from within the U-shaped channel down said lower water drainage channel and out of said slider window assembly.

15. The slider window assembly of claim 14, wherein an upper surface of the bottom wall of the U-shaped channel is sloped downward toward the first side wall so that water present in the U-shaped channel will flow toward the first side wall.

16. The slider window assembly of claim 13, wherein said water drainage channel is aligned with said lower water drainage channel with the inlet at the bottom wall and/or the first side wall of the U-shaped channel disposed at a junction of said water drainage channel and said lower water drainage channel.

17. The slider window assembly of claim 12, wherein the first side wall of the U-shaped channel of said lower rail comprises an attaching surface that receives adhesive thereat at regions separated from said water drainage channel for adhesively attaching said lower rail at said at least one fixed window panel.

18. The slider window assembly of claim 17, wherein a protruding lip at the first side wall establishes a border along each side of said water drainage channel to separate the attaching surface from said water drainage channel, and wherein the protruding lips engage said at least one fixed window panel to limit water flowing through said water drainage channel from flowing to the attaching surface.

19. The slider window assembly of claim 12, wherein said water drainage channel comprises at least one baffle established therein, and wherein the at least one baffle comprises at least one protrusion at the recess along the first side wall of the U-shaped channel, and wherein the at least one protrusion engages said at least one fixed window panel so that water flowing downward through said water drainage channel changes direction at the at least one baffle.

20. The slider window assembly of claim 12, wherein said at least one fixed window panel comprises a single fixed window panel having an opening therethrough.

21. The slider window assembly of claim 12, wherein said at least one fixed window panel comprises first and second fixed window panels defining an opening therebetween.
